(19) United States
(12) Patent Application Publication
(10) Pub. No.: US 2026/0056165 A1
(43) Pub. Date: Feb. 26, 2026

(54) IONIZATION DEVICE, ION DETECTION APPARATUS, AND GAS ANALYSIS APPARATUS

(71) Applicants: Katsuya UJIMOTO, Hyogo (JP); Kunihiro TAN, Hyogo (JP)

(72) Inventors: Katsuya UJIMOTO, Hyogo (JP); Kunihiro TAN, Hyogo (JP)

(21) Appl. No.: 19/127,755

(22) PCT Filed: Dec. 21, 2023
(86) PCT No.: PCT/IB2023/063077

§ 371 Date: May 7, 2025

(30) Foreign Application Priority Data
Dec. 23, 2022 (JP) 2022-206620
Nov. 20, 2023 (JP) 2023-196664

(51) Int. Cl. G01N 27/624

(52) U.S. Cl. CPC G01N 27/624

(57) ABSTRACT

An ionization device includes a pair of electrodes and a channel tube. A pair of electrodes generate a discharge region. A gas flows through the channel tube. The pair of electrodes include a first electrode and a second electrode. The second electrode is annularly disposed around a tip of the first electrode. A diameter of a gas outflow port of the channel tube through which the gas flows to the discharge region is smaller than a diameter of the second electrode.

### TECHNICAL FIELD

Embodiments of the present disclosure relate to an ionization device, an ion detection apparatus, and a gas analysis apparatus.

### BACKGROUND ART

There has been known an ionization device that includes a pair of electrodes generating a discharge region and a channel tube through which a gas flows.

Patent Literature (PTL) 1 describes a configuration in which a discharge needle and a counter electrode are disposed as a pair of electrodes in a sample introduction tube that is a channel tube.

### CITATION LIST

### Patent Literature

### [PTL 1]

Japanese Patent No. 5094520

### SUMMARY OF INVENTION

### Technical Problem

However, there is a problem that the rate of gas ionization is low.

### Solution to Problem

In order to solve the above-described problem, according to an embodiment of the present disclosure, an ionization device includes a pair of electrodes and a channel tube. A pair of electrodes generate a discharge region. A gas flows through the channel tube. The pair of electrodes include a first electrode and a second electrode. The second electrode is annularly disposed around a tip of the first electrode. A diameter of a gas outflow port of the channel tube through which the gas flows to the discharge region is smaller than a diameter of the second electrode.

### Advantageous Effects of Invention

According to at least one embodiment of the present disclosure, the rate of gas ionization can be increased.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a schematic configuration diagram of a gas analysis apparatus of the present embodiment.

FIG. 2 is a functional diagram of an ion detection apparatus.

FIG. 3 is a schematic diagram illustrating an ion detection apparatus.

FIG. 4 is a schematic exploded view of the ion detection apparatus.

FIG. 5 is an exploded external view of the ion detection apparatus.

FIG. 6 is a schematic cross-sectional view of the ion detection apparatus.

FIG. 7 is a schematic perspective view of a main part of an ionization device of a comparative example.

FIG. 8 is a cross-sectional view of the main part of the ionization device of the comparative example.

FIG. 9 is a schematic configuration diagram of a main part of an ionization device 1 of the present embodiment.

FIG. 10 is a diagram for describing a flow of gas inside an outflow tube.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of the present disclosure will be described with reference to the drawings. Note that it is easy for a person skilled in the art to change and modify the content of the present disclosure within the scope of the claims to form other embodiments, and these changes and modifications are included in the scope of the claims. The following describes example embodiments of the present disclosure, and does not limit the scope of the claims.

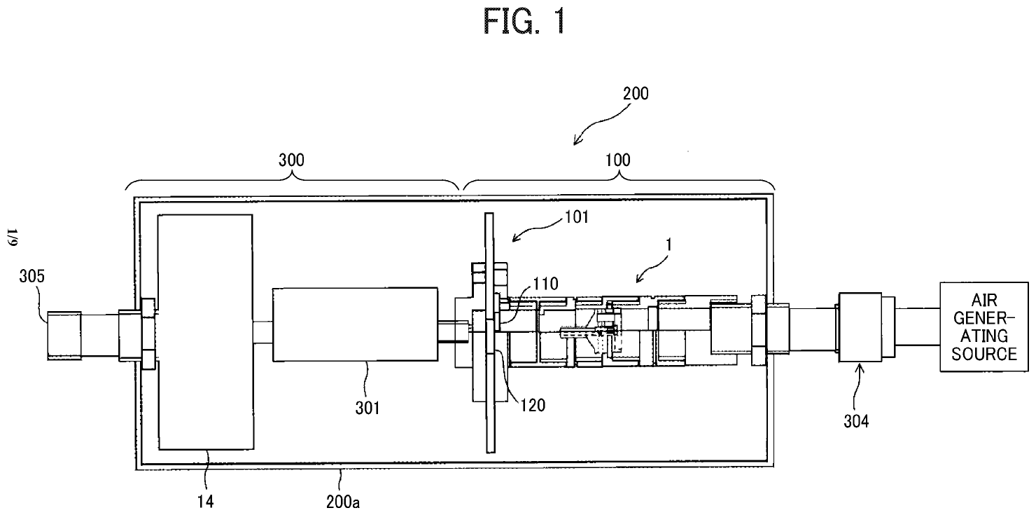

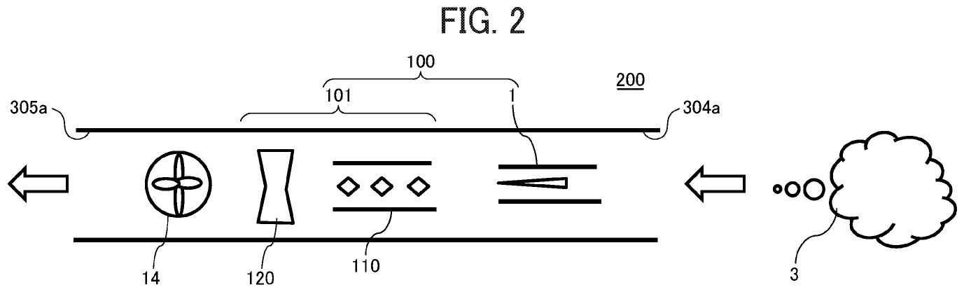

FIG. 1 is a schematic configuration diagram of a gas analysis apparatus 200 of the present embodiment including an ionization device of the present disclosure. FIG. 2 is a functional diagram of the gas analysis apparatus 200.

The gas analysis apparatus 200 of the present embodiment is a field asymmetric ion mobility spectrometry (FAIMS) apparatus, and includes an ion detection apparatus 100 including an ionization device 1 and a gas conveyance apparatus 300. The gas conveyance apparatus 300 includes a flow rate sensor 301 and a vacuum pump 14, and the vacuum pump 14 is controlled so that the flow rate is constant based on the result of detection by the flow rate sensor 301.

The ion detection apparatus 100 and the gas conveyance apparatus 300 are housed in a case 200a. An intake portion 304 that takes in a gas is provided on one side surface of the case 200a (right side surface in the drawing), and an exhaust portion 305 that discharges a gas is provided on the other side surface (left side surface in the drawing). The intake portion 304 includes an intake port for taking in gas from a gas generation source, and the exhaust portion 305 includes an exhaust port for discharging a gas.

As illustrated in FIG. 2, a gas 3 taken in from an intake port 304a of the intake portion 304 by a vacuum pump 14 flows in the channel of the ion detection apparatus 100, is ionized by the ionization device 1, then is selected by an ion filter 110, and is detected by an ion detection electrode 120. The components of the gas 3 are analyzed based on the result of the detection by the ion detection electrode 120. The analysis result is displayed on an external monitor connected to the apparatus or a monitor included in the gas analysis apparatus 200. Then, the gas 3 that has passed through the ion detection apparatus 100 is discharged from an exhaust port 305a of the exhaust portion 305.

The gas analysis apparatus 200 of the present embodiment can be used, for example, for analysis of components of a fecal odor gas emitted from feces. The relationship between the condition of the bacterial flora in the intestine and the condition of health has been attracting attention recently. There are hundreds of kinds of intestinal bacteria living in the human intestine, and these intestinal bacteria are roughly classified into good bacteria, bad bacteria, and opportunistic bacteria. There is a theory that the ideal composition ratio (balance) among these bacteria is “2:1:7”. It is said that the balance among these intestinal bacteria varies with each person and age, and can be a barometer of health. It is said that dietary habits and lifestyle disorder, stress, constipation, and the like promote the growth of bad bacteria, and generate gases with a putrefactive odor, sometimes resulting in carcinogens. Therefore, studies have been conducted to analyze the components of fecal odor gas emitted from feces and examine the condition of bacterial flora, and to grasp the condition of health and detect diseases at an early stage. The gas analysis apparatus 200 can be used to analyze such components of the fecal odor gas.

The gas analysis apparatus 200 of the present embodiment can also be used, for example, for analysis of components contained in exhalation of a human. In recent years, the relationship between a minute amount of an exhaled gas component in exhaled human breath and diseases has been becoming clear. The exhaled gas component whose concentration in the breath correlates with diseases is called a marker substance. The gas analysis apparatus 200 of the present embodiment can also be used for analysis of such exhaled gas components. In addition, the gas analysis apparatus 200 of the present embodiment can also be used to detect alcohol as an exhaled gas component contained in exhalation of a human.

Note that these are examples, and the gas analysis apparatus 200 of the present embodiment can also be used for sensory evaluation (olfactory sensation) of food and drink (alcohol type), environmental evaluation of a predetermined place such as a room, fire detection, and the like, for example.

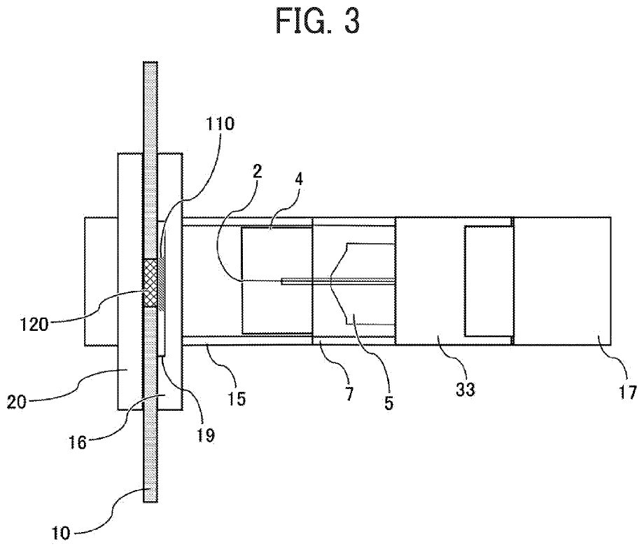

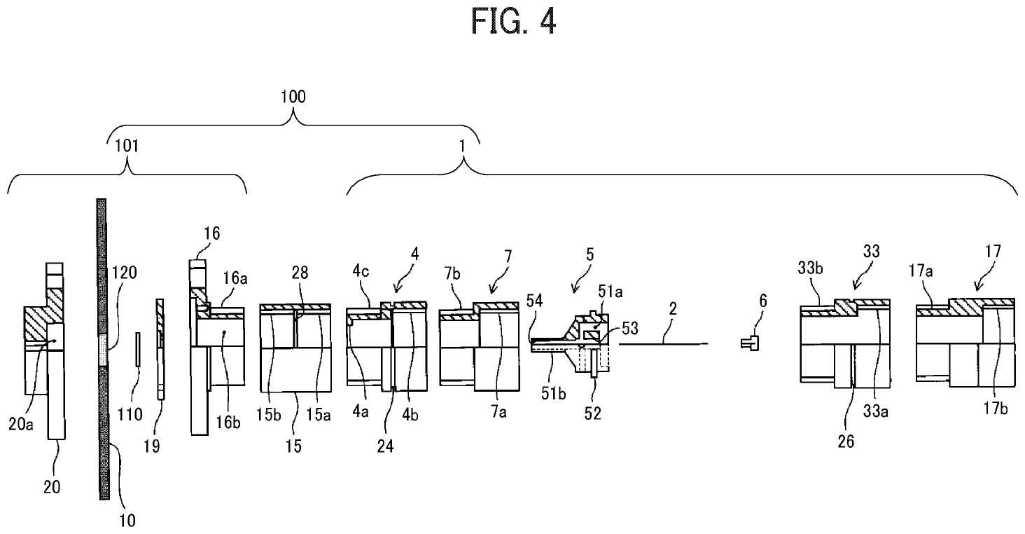

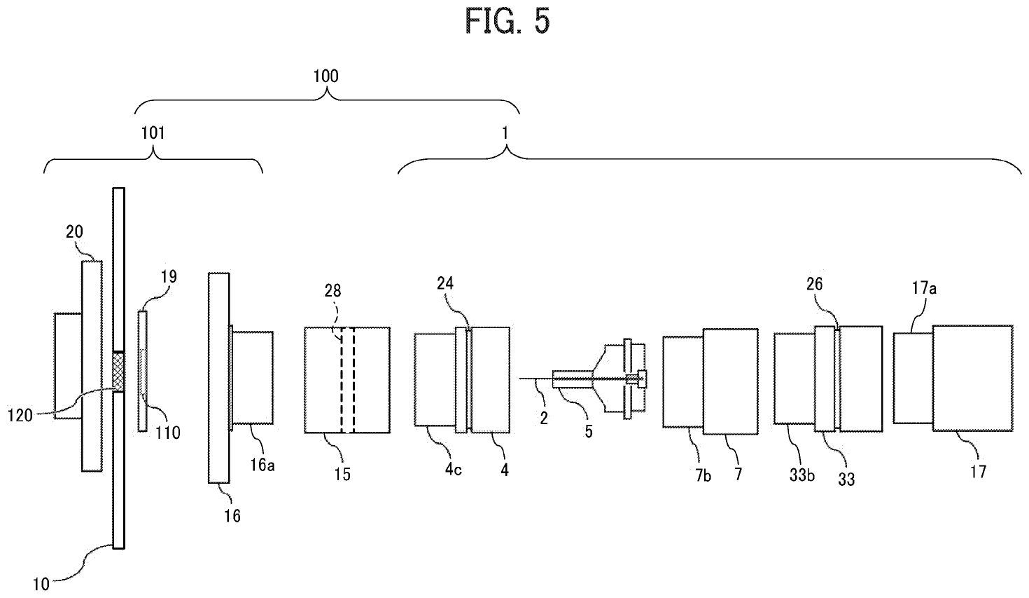

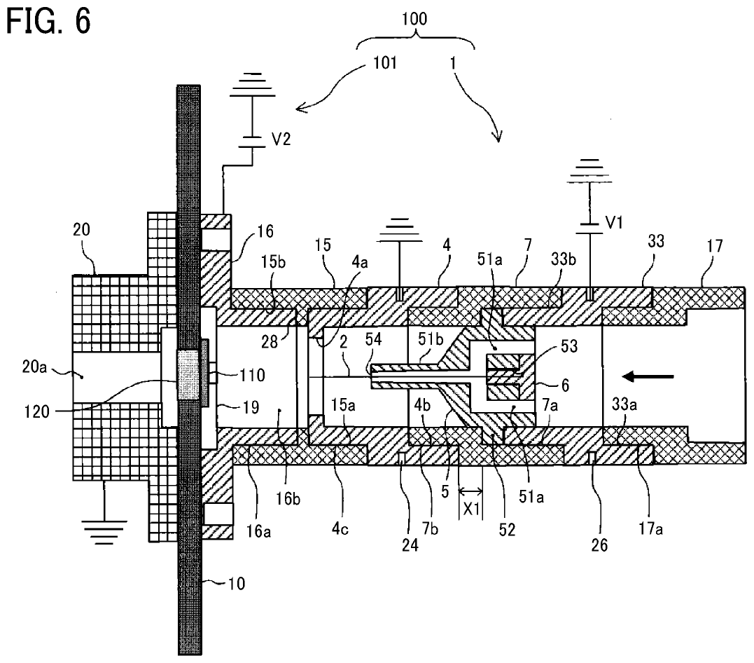

FIG. 3 is a schematic diagram illustrating the ion detection apparatus. FIG. 4 is a schematic exploded view of the ion detection apparatus 100, FIG. 5 is an exploded external view of the ion detection apparatus 100, and FIG. 6 is a schematic cross-sectional view of the ion detection apparatus 100. In FIG. 4, the upper portion illustrates a cross section, and a lower portion illustrates an external appearance.

The ion detection apparatus 100 includes an ionization device 1 and an ion detection unit 101, which are modularized.

The ionization device 1 includes a discharge needle 2 that is a discharge electrode and is a first electrode, an electrode tube 4 including an electrode portion 4a that is a second electrode facing a tip of the discharge needle 2, and a channel member 5 that flows a gas taken from a gas generation source through the intake port 304a to a discharge region of the discharge needle 2. The ionization device 1 also has a conductive electrode holder 6 that holds the discharge needle 2 and is fitted into a holder fitting portion 53 of the channel member 5. The discharge needle 2 penetrates an outflow tube 51b that is a channel tube of the channel member 5, and a tip 2a of the discharge needle 2 is located downstream in the gas flow direction of an outflow port 54 through which the gas in an outflow tube 51 flows out.

The ionization device 1 includes an insulating adapter 17 and an electrode adapter 33. The electrode adapter 33 is electrically connected to a power supply, and inputs a high voltage V1 to the discharge needle 2 through the channel member 5 and the electrode holder 6. The ionization device 1 also includes an insulating holder 7 that prevents electrical connection between the electrode adapter 33 and the electrode tube 4.

The external shape of the ionization device 1 is a substantially cylindrical shape with a diameter of about 10 mm. The external shape of the ionization device 1 is formed by forming the insulating adapter 17, the electrode adapter 33, the insulating holder 7, and the electrode tube 4 into a substantially cylindrical shape with a diameter of about 10 mm.

The insulating adapter 17 is a cylindrical member that is made of an insulating resin and has a hole formed inside a cylindrical shape by cutting or the like, and the taken gas moves in the insulating adapter 17. The outer peripheral surface of the insulating adapter 17 has a male screw portion 17a formed on the downstream side in the gas flow direction indicated by an arrow in FIG. 6. Screwed to the male screw portion 17a is a female screw portion 33a formed on the inner peripheral surface of the electrode adapter 33 on the upstream side in the gas flow direction. Accordingly, it is possible to reduce the leakage of the gas from the connection portion between the electrode adapter 33 and the insulating adapter, and easily remove the electrode adapter 33 from the insulating adapter 17.

In the present embodiment, the insulating adapter 17 and the electrode adapter 33 are screwed. Alternatively, for example, the insulating adapter 17 may be made of a material excellent in slidability such as polyacetal or polyethylene, and the electrode adapter 33 may be secured to the insulating adapter 17 by a fitting method.

Since the gas taken from the gas generation source through the intake port flows into the insulating adapter 17, the resin material of the insulating adapter 17 is selected considering the scaling performance against the taken gas.

The electrode adapter 33 also has a cylindrical shape for allowing a gas to flow therethrough, and is made of an electrically conductive material. In the present embodiment, the electrode adapter 33 is formed by cutting an easy-to-process metal such as stainless steel or aluminum. The outer peripheral surface of the electrode adapter 33 has a ring-shaped groove 26 into which a connector of a cable connected to a high-voltage power supply is fitted.

The outer peripheral surface of the electrode adapter 33 has a male screw portion 33b formed on the downstream side in the gas flow direction. The male screw portion 33b is screwed to a female screw portion 7a formed on the inner peripheral surface of the insulating holder 7 on the upstream side in the gas flow direction.

The outer peripheral surface of the channel member 5 has a connection convex portion 52 electrically connected to the electrode adapter 33. When the electrode adapter 33 is screwed to the insulating holder 7, the connection convex portion 52 is sandwiched between the electrode adapter 33 and the insulating holder 7 in the gas flow direction. Accordingly, the connection convex portion 52 and the electrode adapter 33 are in close contact with each other, the electrode adapter 33 and the channel member 5 are electrically connected to each other, and the channel member 5 can be set to the same potential as the electrode adapter 33.

The channel member 5 and the electrode adapter 33 may be electrically connected by accurately processing the members and fitting the channel member 5 into the electrode adapter 33. Specifically, the channel member 5 and the electrode adapter 33 can be fitted and electrically connected in a favorable manner by cutting the channel member 5 and the electrode adapter 33 with an accuracy of several microns. In addition, since the channel member 5 and the electrode adapter 33 are formed of high-hardness metal, the channel member 5 and the electrode adapter 33 are not deformed and the electrical connection between them by fitting can be favorably maintained.

The channel member 5 includes a plurality of inflow tubes 51a and the outflow tube 51b that is a channel tube, and is made of a conductive material. In the channel member 5, the connection convex portion 52 is sandwiched and fixed between the electrode adapter 33 and the insulating holder 7, and is fitted and attached to the insulating holder 7. Therefore, the material of the channel member 5 is preferably a metal that has high hardness and is hardly deformed. As will be described later, the insulating holder 7 is made of a resin having a sliding property, and the channel member 5 can be easily removed from the insulating holder 7 even when the insulating holder 7 is attached by fitting.

Since the channel member 5 and the electrode adapter 33 are both made of metal, the channel member 5 and the electrode adapter 33 are fitted with a gap having a predetermined play from the viewpoint of case of removal.

The channel member 5 is formed of a circular tube conductor, and may have a thickness of several 100 μm or more so as to withstand the pressure of gas. The channel member 5 is formed into a circular tube shape by cutting a cylindrical material. The channel member 5 is preferably made of metal such as aluminum, copper, or brass which is easy to process and is hardly deformed.

The plurality of inflow tubes 51a is provided at predetermined intervals in the circumferential direction of the channel member 5, and the outflow tube 51b is provided at the center of the channel member 5. Although one inflow tube 51a may be provided, it is preferable to provide a plurality of inflow tubes 51a because the total area of the gas inflow ports can be increased and the air resistance at the time of inflow can be reduced.

The gas flowing into the inflow tubes 51a merges near the central portion and is released from the outflow port 54 of the outflow tube 51b toward the tip of the discharge needle 2.

The channel member 5 has the holder fitting portion 53 into which the electrode holder 6 holding the discharge needle 2 is fitted, at the center of the side surface on the upstream side in the gas flow direction. The electrode holder 6 is made of a conductive and easy-to-process material, and holds the discharge needle 2 with the base fitted thereto, so that the electrode holder 6 and the discharge needle 2 are electrically connected.

When the electrode holder 6 made of a conductive material is fitted into the holder fitting portion 53 of the channel member 5, the channel member 5 and the electrode holder 6 are electrically connected. Consequently, the high voltage V1 input to the electrode adapter 33 is input to the discharge needle 2 through the channel member 5 and the electrode holder 6. When the electrode holder 6 is fitted into the holder fitting portion 53 of the channel member 5, the discharge needle 2 penetrates the outflow tube 51b, and the tip 2a of the discharge needle 2 is located on the downstream side of the outflow port 54 of the outflow tube 51b in the gas flow direction.

In the present embodiment, the high voltage V1 input to the discharge needle 2 is input via the electrode adapter 33, the channel member 5, and the electrode holder 6. Accordingly, the channel member 5, the discharge needle 2, and the electrode holder 6 can be set to the same potential, thereby preventing abnormal discharge between the outflow tube 51b and the discharge needle 2.

The insulating holder 7 that prevents electrical connection between the electrode adapter 33 and the electrode tube 4 is cylindrical in shape, and has the female screw portion 7a on the inner peripheral surface on the upstream side in the gas flow direction. The female screw portion 7a is screwed to the male screw portion 33b on the outer periphery of the electrode adapter 33 on the downstream side in the gas flow direction.

The outer peripheral surface of the insulating holder 7 has the male screw portion 7b on the downstream side in the gas flow direction. Screwed to the male screw portion 7b is the female screw portion 4b on the inner peripheral surface of the cylindrical electrode tube 4 on the upstream side in the gas flow direction. The insulating holder 7 may be fitted and attached to the electrode adapter 33 and the electrode tube 4.

The insulating holder 7 is made of a general resin. A material having workability with which accuracy can be obtained by cutting and having high insulation resistance is selected. This is because the electrode tube 4 is grounded and the high voltage V1 of several kV is applied to the electrode adapter 33 and the channel member 5. Therefore, an electric field of several kV is generated between the electrode tube 4 and the electrode adapter 33 and the channel member 5, and the insulating holder 7 is responsible for the insulation. This makes it necessary to select a material having high insulation resistance for the insulating holder 7.

In addition, a slightly soft material such as polyacetal or polyethylene is preferable for the insulating holder 7 so that the channel member 5 fitted and attached to the insulating holder 7 can be easily removed from the insulating holder 7. Using a slightly soft material reduces cracks and the like caused by stress. This makes it possible to reduce a decrease in insulation resistance due to cracks.

A thickness X1 (see FIG. 6) between the electrode tube 4 of the insulating holder 7 and the connection convex portion 52 of the channel member 5 is set to a sufficient thickness so as not to cause a short circuit or discharge between the electrode tube 4 and the connection convex portion 52 of the channel member 5.

The electrode tube 4 has a tubular shape and includes the electrode portion 4a that forms a pair of electrodes for generating a discharge region with the tip of the discharge needle 2. The outer peripheral surface of the electrode tube 4 has a ring-shaped groove 24 into which a connector of a cable connected to the ground is fitted, in a substantially central portion in the gas flow direction. When the electrode tube 4 is connected to the ground, it is possible to set the potential of the electrode portion 4a of the electrode tube 4 to a potential serving as a reference of circuit operation.

In order to ensure stability of discharge, the electrode tube 4 needs to avoid formation of oxides and adhesion of foreign matter to the surface. Therefore, the material of the electrode tube 4 is preferably stainless steel.

The distance between the discharge needle 2 and the electrode portion 4a that is provided at the end of the electrode tube 4 on the downstream side in the gas flow direction and protrudes inward is shorter than the distance between the electrode tube 4 and the outflow tube 51b. The outer peripheral surface of the electrode tube 4 has a male screw portion 4c on the downstream side in the gas flow direction. Screwed to the male screw portion 4c is a coupling holder 15 that couples the ion detection unit 101 and the ionization device 1.

The coupling holder 15 has a tubular shape and is made of an insulating material. In the present embodiment, the coupling holder 15 is formed of a resin. The coupling holder 15 has female screw portions 15a and 15b formed on sides of the inner peripheral surface. The electrode tube 4 is screwed to the female screw portion 15a on the upstream side in the gas flow direction. Screwed to the female screw portion 15b on the downstream side in the gas flow direction is a male screw portion 16a formed on the outer peripheral surface of a first flange 16 of the ion detection unit 101.

The inner peripheral surface of the coupling holder 15 has an insulating convex portion 28 protruding inward at a substantially central portion in the gas flow direction. When the ion detection unit 101 and the ionization device 1 are coupled by the coupling holder 15, the insulating convex portion 28 is positioned so as to be sandwiched between the downstream end in the gas flow direction of the electrode tube 4 and the upstream end in the gas flow direction of the first flange 16 in the gas flow direction. This makes it possible to readily ensure insulation between the first flange 16 and the electrode tube 4.

As described later, in order to move the gas having the charge ionized by the discharge needle 2 to the ion filter 110, a voltage V2 is applied to the first flange 16 and a chip holder 19 holding the ion filter 110. Providing the insulating convex portion 28 on the coupling holder 15 to reliably ensure insulation between the first flange 16 and the electrode tube 4 makes it possible to favorably maintain the potential difference between the first flange 16 and the chip holder 19 and the electrode tube. Accordingly, the neutral gas having no charge and the ionized gas can be properly separated.

The voltage applied to the channel portion 16b through which the ionized gas in the first flange 16 flows may be increased stepwise in the gas flow direction, and the ionized gas having charges may be favorably moved to the ion filter 110.

The ion detection unit 101 includes the ion filter 110 and the ion detection electrode 120. The ion filter 110 is held by the chip holder 19, and the ion detection electrode 120 is mounted on a circuit board 10.

The ion detection unit 101 includes the first flange 16 that holds the chip holder 19. The first flange 16 has the channel portion 16b through which the gas ionized by the ionization device 1 flows toward the ion filter 110.

The ion detection unit 101 also includes a second flange 20 including an extraction port for extracting the wiring of the ion filter 110 and a channel 20a for letting the gas having passed through the ion detection electrode 120 flow to the gas conveyance apparatus 300. When the second flange 20 is screwed and secured to the first flange 16, the circuit board 10 is sandwiched and fixed between the first flange 16 and the second flange 20.

The ion filter 110 has a pair of opposing ion filter electrodes and controls the mobility of ions passing therethrough. The passing ions having passed through the ion filter 110 collide with the ion detection electrode 120. That is, the passing ions come into contact with the ion detection electrode 120. Then, the ion detection electrode 120 detects the passing ions, and outputs an electrical characteristic value corresponding to the intensity of the contact. The electrical characteristic value may be a current value, a voltage value, or a resistance value, for example. The ion detection unit 101 is preferably provided with an insulating material that electrically insulates the ion detection electrode 120 from the pair of ion filter electrodes of the ion filter 110.

The ion detection apparatus 100 includes an ion current detection circuit connected to the ion detection electrode 120. The ion current detection circuit detects a current or a voltage generated according to the amount of ions having collided with the ion detection electrode 120.

The voltage V2 is applied to the first flange 16 and the chip holder 19 holding the ion filter 110, thereby forming a potential difference of several V to several tens V between the electrode tube 4 and these components. Due to this potential difference, the gas ionized by the discharge needle 2 is drifted by the potential, and preferentially moves to the ion filter 110. Accordingly, the gas moving to the ion filter 110 can be sorted into a neutral gas having no charge and a gas having ionized charges, and the ionization concentration of the gas moving to the ion filter 110 can be improved.

The gas 3 (see FIG. 2) taken from a gas generation source through the intake port 304a by the vacuum pump 14 flows in the tubes of the insulating adapter 17 and the electrode adapter 33, and then flows into the plurality of inflow tubes 51a of the channel member 5. Then, the gas 3 having flown into the inflow tubes 51a is changed in flow direction by 90°, merges near the central portion, and flows through the outflow tube 51b. Then, the gas 3 is released from the outflow port 54 of outflow tube 51b in the flow velocity direction aligned, and is efficiently guided to the tip of discharge needle 2.

When the gas 3 moves in the electrode tube 4 and passes through the discharge region formed by the tip of the discharge needle 2 and the electrode portion 4a protruding inward of the electrode tube 4 at the downstream end in the gas flow direction, the gas 3 is ionized by the discharge from the tip of the discharge needle 2. The ionized gas 3 moves toward the ion filter 110 in the channel portion 16b of the first flange 16 of the ion detection unit 101, and the mobility of the gas is controlled by the ion filter 110. Thereafter, the gas collides with the ion detection electrode 120 and is detected by the ion detection electrode 120. The gas that has passed through the ion detection electrode 120 moves in the second flange 20, flows to the gas conveyance apparatus 300, and is then discharged from the exhaust port of the exhaust portion 305 by the vacuum pump 14.

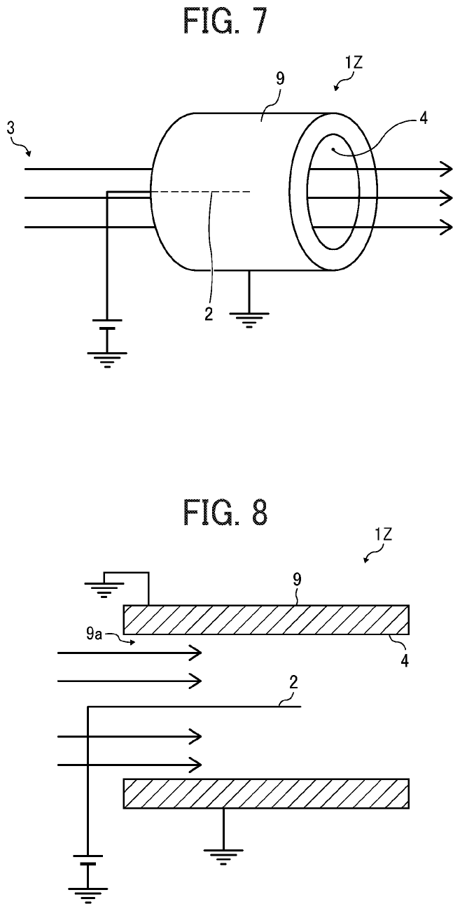

FIG. 7 is a schematic perspective view of a main part of an ionization device 1Z of a comparative example, and FIG. 8 is a cross-sectional view of the main part of the ionization device 1Z of the comparative example.

As illustrated in FIGS. 7 and 8, in the ionization device 1Z of the comparative example, a channel tube 9 that flows the taken gas to the tip of a discharge needle 2 also functions as an electrode tube 4. The discharge needle 2 has a needle shape for concentrating an electric field, and the region where the gas is ionized is limited to a local region at the tip of the discharge needle 2.

In the ionization device 1Z of the comparative example, a large amount of gas flowing in the channel tube 9 flows at a position different from the local discharge region at the tip of the discharge needle 2. Therefore, most of the taken gas is not ionized, and the efficiency of ionization is low.

Thus, it is conceivable to shorten the diameter of the channel tube 9. However, if the diameter of the channel tube 9 is shortened, there is a possibility that a discharge occurs at a position other than the tip of the discharge needle, and the range of discharge is extended. When the range of discharge is extended, uneven discharge may occur, and the gas may be ionized in an uneven manner.

In the comparative example illustrated in FIGS. 7 and 8, the tip of the discharge needle 2 is located in the channel tube 9 that is the electrode tube. In such a configuration, the discharge at the tip of the discharge needle 2 spreads to the downstream side in the gas flow direction of the inner wall of the electrode tube 4. In this manner, since the discharge spreads to the downstream side in the gas flow direction, the probability of contact with the gas decreases, and the efficiency of ionization may decrease.

A typical ionization device aims to neutralize static electricity in a large area at once. Therefore, the ionization device pressurizes the inlet of a channel and its vicinities to flow the gas into the channel, and vigorously ejects the gas near the outflow port. In particular, development of a shrink-enlarged nozzle shape such as a Laval nozzle shape has been accelerated these days. Indeed, with these nozzle shapes, it is possible to achieve a high velocity exceeding the sound velocity, and send a large amount of gas into the discharge region.

However, since the amount of ionization per unit time by discharge from the discharge needle 2 is limited, if the flow rate is too fast, the concentration of ionized molecules, which is the ratio of the number of ionized molecules to the number of neutral molecules, decreases.

As described above, the ionization device of the comparative example has a problem of low efficiency of ionization. Thus, in the ionization device of the present embodiment, the efficiency of ionization is enhanced by devising the shape of the channel and separating the functions of the electrode tube and the channel tube as different members. Hereinafter, features of the present embodiment will be described with reference to the drawings.

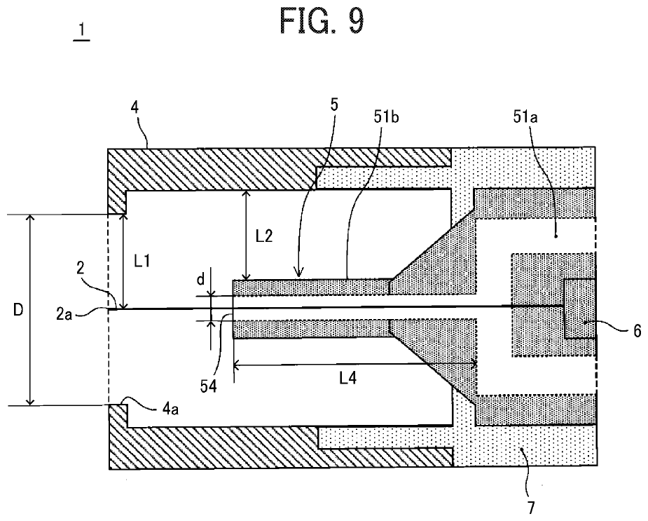

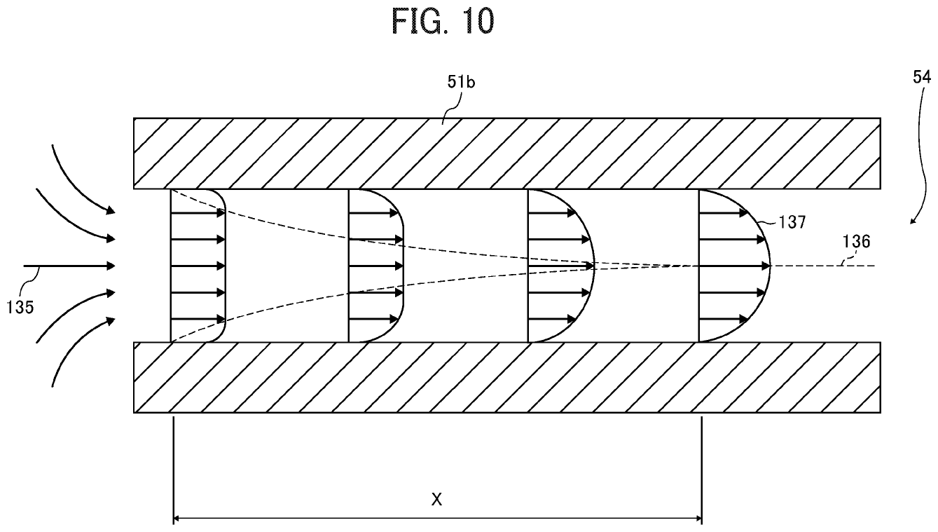

FIG. 9 is a schematic configuration diagram of a main part of the ionization device 1 of the present embodiment.

As illustrated in FIG. 9, in the present embodiment, the tip 2a of the discharge needle 2 is located at the same position in the gas flow direction as the electrode portion 4a that protrudes inward at the downstream end of the electrode tube 4 in the gas flow direction. The same position here means that the tip 2a of the discharge needle 2 is located within the width of the electrode portion 4a at which the tip 2a protrudes (the length of the electrode portion in the gas flow direction). In addition, a distance L1 between the electrode portion 4a that protrudes inward at the downstream end of the electrode tube 4 in the gas flow direction and the tip 2a of the discharge needle 2 is shorter than a distance L2 between the electrode tube 4 and the outflow tube 51b (L1<L2).

In the present embodiment, as described above, in order to prevent abnormal discharge between the outflow tube 51b and the discharge needle 2, the outflow tube 51b has the same potential as the discharge needle 2. As illustrated in FIGS. 6 and 9, a part of the electrode tube 4 connected to the ground faces a part of the outflow tube 51b, and an electric field is formed between the electrode tube 4 and the outflow tube 51b.

However, in the present embodiment, the electrode portion 4a facing the tip 2a of the discharge needle 2 of the electrode tube 4 protrudes inward, and the distance L1 from the discharge needle 2 is shorter than the distance L2 between the electrode tube 4 and the outflow tube 51b (L1<L2). Accordingly, the electric field between the tip 2a of the discharge needle 2 and the electrode portion 4a can be maximized, and stable discharge can be generated dominantly between the tip 2a of the discharge needle 2 and the electrode portion 4a. This favorably reduces the occurrence of abnormal discharge between the electrode tube 4 and the outflow tube 51b. In addition, since stable discharge is performed between the tip 2a of the discharge needle 2 and the electrode portion 4a, the efficiency of ionization can be enhanced.

For example, the insulating holder 7 may be located downstream of the outflow port 54 of the outflow tube 51b in the gas flow direction, and the insulating holder 7 may be interposed between the outflow tube 51b and the electrode tube 4 to perform insulation, thereby reducing abnormal discharge between the electrode tube 4 and the outflow tube 51b.

Arranging the tip 2a of the discharge needle 2 at the same position (within the width of the electrode portion 4a) as the electrode portion 4a protruding inward at the downstream end of the electrode tube 4 in the gas flow direction makes it possible to perform stable discharge and enhance the efficiency of ionization. In addition, disposing the tip 2a of the discharge needle 2 at the same position in the gas flow direction as the downstream end of the electrode portion 4a in the gas flow direction (which is also the downstream end of the electrode tube 4) favorably further increases the amount of ions. This is because, as a result of an intensive experiment, an effect to maximize the amount of ions was obtained with such arrangement. It is known that a sufficient effect can be expected if the accuracy of alignment is about 100 micrometers.

Since the downstream end of the electrode portion 4a in the gas flow direction has a sharp shape, the line of electric force is attracted to the end. Accordingly, the discharge can be concentrated on the end of the electrode portion 4a, and the discharge can be prevented from spreading to the downstream side in the gas flow direction, as compared with the apparatus according to the comparative example illustrated in FIGS. 7 and 8 in which the tip of the discharge needle 2 is located in the electrode tube. Accordingly, it is considered that the discharge can be favorably performed in the direction orthogonal to the gas flow direction, the probability of contact with the gas can be improved, the amount of gas molecules to be ionized is increased, and the efficiency of ionization is improved.

The surface of the electrode portion 4a facing the tip 2a of the discharge needle 2 in the direction perpendicular to the gas flow direction is polished, and the surface has an arithmetic average roughness (Ra) of 10 μm or less. The accuracy of alignment between the downstream end of the electrode portion 4a and the tip 2a of the discharge needle 2 is produced with high inspection accuracy so that the electrode portion 4a and the tip 2a can be manufactured with high reproducibility using a high-accuracy mounting technique in a manufacturing process.

Specifically, the downstream end of the electrode portion 4a and the tip 2a of the discharge needle are aligned by a passive mounting method with machine accuracy. In the passive mounting method, a flat plate is pressed against the end portion of the electrode tube 4 to which the discharge needle 2 is temporarily fixed, and the discharge needle 2 protruding beyond the flat plate is pressed by the flat plate, whereby the positions of the downstream end of the electrode portion 4a, which is also the downstream end of the electrode tube 4, and the tip 2a of the discharge needle 2 are aligned with each other with accuracy due to flatness of the flat plate. Then, a microscope having a telecentric optical system is used to inspect the status of alignment between the downstream end of the electrode portion 4a and the tip 2a of the discharge needle 2 on the microscope monitor screen.

The electrode portion 4a of the electrode tube 4 is desirably annular. If the electrode portion 4a is annular, when the discharge needle 2 is disposed at the center of the circle, the electrode portion 4a and the tip 2a of the discharge needle 2 are equidistant from each other, a uniform discharge region is formed in the circumferential direction along the electrode portion 4a, and the ionization of the gas can be realized efficiently and reproducibly.

On the other hand, if the electrode portion 4a is not annular, the distance between the tip 2a of the discharge needle 2 and the electrode portion 4a is different in the circumferential direction, a non-uniform discharge region is formed, and ionized molecules also have a non-uniform distribution. The non-uniform ionization generation distribution lowers the accuracy of the analysis result of the gas. In particular, in the case of manufacturing a product exhibiting a gas analysis result with favorable reproducibility, a uniform discharge region is desirably formed by the annular electrode portion 4a.

As described above, the electrode tube 4 constitutes a part of the external appearance of the cylindrical ionization device 1 having a diameter of about 10 mm. Therefore, the outer diameter of the electrode tube 4 is about 10 mm. Since the electrode tube 4 is screwed to the male screw portion of the insulating holder 7 having an outer diameter of about 10 mm, which constitutes a part of the external appearance of the ionization device 1, an inner diameter D of the electrode tube 4 also increases as illustrated in FIG. 9. As in the comparative example, in the case where the electrode tube 4 also has the function of the channel tube that flows the taken gas to the tip 2a of the discharge needle 2, a large amount of the taken gas flows at the position different from the local discharge region at the tip 2a of the discharge needle 2. Therefore, most of the taken gas is not ionized, and the efficiency of ionization is low.

On the other hand, in the present exemplary embodiment, the channel member 5 for flowing the gas to the tip 2a of the discharge needle 2 is provided separately from the discharge needle 2 and the electrode tube 4 forming a pair of electrodes, thereby to separate functions. Accordingly, the shapes of these components can be designed without constraints. Therefore, the shape of the outflow tube 51b through which the taken gas in the channel member 5 flows to the discharge region can be designed as a shape with which the taken gas can be most efficiently ionized.

Specifically, the outflow tube 51b through which the taken gas in the channel member 5 flows to the discharge region has a shape in which the discharge needle 2 is disposed at a concentric position and the outflow tube 51b is extended in parallel with the discharge needle 2. A diameter (inner diameter) d of the outflow port 54 of the outflow tube 51b through which the gas flows to the discharge region is made smaller than the diameter (inner diameter) D of the electrode portion 4a (D>d).

Since the discharge needle 2 and the outflow tube 51b are parallel to each other, the gas released from the outflow port 54 of the outflow tube 51b is guided and flown into the tip 2a of the discharge needle 2. In addition, since the diameter d of the outflow port 54 is made smaller than the inner diameter D of the electrode portion 4a, makes it possible to prevent the taken gas from flowing to a position different from the local discharge region at the tip of the discharge needle 2.

As described above, the outflow tube 51b is designed such that the taken gas passes around the discharge needle 2 alone (such that the discharge needle 2 is disposed at a concentric position and the outflow tube 51b is extended in parallel with the discharge needle 2, and the diameter (inner diameter) d of the outflow port 54 through which the gas flows to the discharge region at the tip is made smaller than the diameter (inner diameter) D of the electrode tube 4), whereby a large amount of gas can be ionized. Accordingly, the taken gas can be efficiently ionized.

In the present embodiment, a channel length L4 of the outflow tube 51b is set such that the Reynolds number of the flow of the gas is reduced to be lower than that when the flow of the gas is supplied to the outflow tube 51b and the gas is released from the outflow port 54. Preferably, the channel length L4 of the outflow tube 51b is set so that the gas is released from the outflow port 54 in a laminar flow.

The Reynolds number represents the ratio between the viscous force and the inertial force in a flow of a viscous fluid in fluid dynamics (the formula will be described later). In general, in a flow with a low Reynolds number, the viscous force of the fluid is dominant, and therefore, the flow is stable (the flow turns into a laminar flow). In a flow with a high Reynolds number, on the other hand, the inertial force is dominant, and therefore, the flow is unstable (the flow turns into a turbulent flow). The Reynolds number of the flow of the gas is reduced to be lower than that when the gas is supplied to the outflow tube 51b, and the gas is released from the outflow port 54 in a laminar flow, so that the gas released from the outflow port 54 can flow in parallel to the direction of the outflow tube 51b (straightly toward the tip of the discharge needle 2) as compared with a turbulent flow. Accordingly, the taken gas can pass around the discharge needle 2 alone, and the taken gas can be efficiently ionized. A specific description will be given below with reference to FIG. 10. Although the outflow tube 51b has an annular shape in the present embodiment, the following theory holds even if the outflow tube is rectangular in shape as long as the outflow tube has a side wall.

FIG. 10 is a schematic diagram illustrating a flow of gas inside the outflow tube 51b. As illustrated in FIG. 10, when the gas is supplied to the outflow tube 51b, the gas is affected by a sidewall inside the outflow tube 51b. The flow of the gas affected by the sidewall is referred to as a boundary layer 136, and the boundary layer 136 develops as the gas flows toward the downstream side in the outflow tube. Then, as the boundary layer 136 develops, the velocity distribution of the flow changes to a parabolic shape, and finally, the flow becomes a developed flow (laminar flow) 137 and is released from the outflow port 54. In this way, when being released as the laminar flow 137 from the outflow port 54, the gas released from the outflow port 54 flows parallel to the direction of the outflow tube 51b (straightly toward the tip 2a of the discharge needle 2).

The length X of the zone of approach to the developed flow 137 in the outflow tube 51b is expressed as in the following Expression (1). In Expression (1), Re represents the Reynolds number, d represents the radius of the tube, and the Reynolds number Re is expressed as in the following Expression (2). In Expression (1), V represents flow velocity, and ν represents kinematic viscosity. For example, the kinematic viscosity of air is 1.512×10⁻⁵ m²/sec.

$$X = ( 0.0 \; 65 ) \times Re \times d \qquad ( 1 )$$

$$Re = V \times d / ν \qquad ( 2 )$$

Further, the kinematic viscosity ν satisfies the relationship expressed in Expression (3), from the viscosity coefficient μ and the density.

$$ν = μ / ρ \qquad ( 3 )$$

ν: kinematic viscosity coefficient of air [m²/s]
μ: viscosity coefficient of air [N·s/m²]
ρ: density of air [kg/m³]

Here, ν represents the kinematic viscosity, which is the numerical value of atmospheric pressure. Since ρ is proportional to the pressure, the kinematic viscosity coefficient ν is higher at a reduced pressure. When the kinematic viscosity coefficient ν becomes higher, the Reynolds number Re becomes lower, according to the relationship expressed in Expression (2). That is, under reduced pressure, the Reynolds number Re becomes lower.

The lowered Reynolds number facilitates the creation of a developed flow (a laminar flow) even in the same approach zone. As described above, providing the channel member 5 separately from the electrode tube 4 makes it possible to form the shape of the outflow tube 51b through which the taken gas flows toward the tip 2a of the discharge needle 2 into a shape with which a laminar flow can be formed, so that the taken gas can be ionized efficiently.

In the present embodiment, as illustrated in FIG. 1, the gas conveyance apparatus 300 is provided downstream of the ion detection apparatus 100 in the gas flow direction, and the pressure in the gas channel of the ion detection apparatus 100 is reduced by the vacuum pump 14 with respect to the atmospheric pressure to take in the gas. The vacuum pump 14 may be of about several tens of kPa or about several tens of liters/minute. Accordingly, the pressure in the channel through which the gas flows of the ion detection apparatus 100 can be reduced with respect to the atmospheric pressure to take in the gas.

When the pressure in the channel through which the gas flows in the ion detection apparatus 100 is reduced with respect to the atmospheric pressure to take in the gas, the outflow port 54 of the outflow tube 51b and its vicinity are brought under a negative pressure, and the gas becomes a fluid having a vector group of molecular movement aligned in one direction from the outflow port 54. This is because there are few collisions between molecules and Brownian motion hardly occurs, which is significantly different from molecular movement with a gas ejected from the outflow port 54 by pressurization.

The movement direction of the gas coming out from the outflow port 54 under the reduced pressure becomes a bundle in the direction along the outflow tube 51b. In the pressurization method as used in the typical ionization device described above, the gas is diffused in all directions from the outflow port 54. As described above, since the gas is released in a bundle from the outflow port 54 in the direction along the outflow tube 51b, the taken gas can be favorably flown into the tip 2a of the discharge needle 2, and the efficiency of ionization can be improved.

In addition, under the reduced pressure, there is also a high possibility that fewer collisions of the flowing gas molecules with the channel surface than under increased pressure will occur, without a change in the direction of movement due to a collision between gases in the outflow tube. Accordingly, the gas can be favorably turned into a laminar flow in the outflow tube, so that the taken gas can pass around the discharge needle 2 alone, and the taken gas can be efficiently ionized.

The channel of the channel member 5 can be deformed, and the channel from the inflow tube 51a to the outflow tube 51b can be tapered to align the movement directions of the gas molecules. The inner peripheral surfaces of the inflow tube 51a and the outflow tube 51b are preferably polished and flattened. This increases the possibility that the reflection direction of the gas molecules follows the outflow port direction after the gas molecules collide with the inner peripheral surface of the tube. In the present embodiment, the pressure in the channel is reduced by the vacuum pump 14, but the pressure in the channel may be reduced by using a fan, a blower, or the like.

The ion detection apparatus 100 of the present embodiment has a configuration in which the members other than the channel member 5 are joined by screws, so that these members can be easily separated. The channel member 5 is fitted and attached to the electrode adapter 33 and the insulating holder 7, and the channel member 5 can be easily removed from the electrode adapter 33 and the insulating holder 7. As described above, since the members of the ion detection apparatus 100 can be easily separated and joined, the members can be easily replaced.

For example, if the tip of the discharge needle 2 is deteriorated, the discharge needle 2 alone can be easily replaced by separating the electrode adapter 33 from the insulating holder 7 to expose the electrode holder 6, and taking out the electrode holder 6 from the holder fitting portion 53 of the channel member 5. With this arrangement, it is possible to easily use a fresh discharge needle 2, and stably perform ion detection by stable discharge.

In the present embodiment, a high voltage is applied to the channel member 5 and the discharge needle 2 disposed inside the ion detection apparatus via the electrode adapter 33 constituting an outer-diameter portion of the ion detection apparatus 100. This makes it possible to make an electrical connection with an external power supply that applies a high voltage on the outer periphery of the ion detection apparatus 100, favorably maintain airtightness of the ion detection apparatus 100, and reduce leakage of the taken gas. Similarly, since the electrode tube 4 also constitutes an outer-diameter portion of the ion detection apparatus 100, it is possible to connect the electrode tube to the ground on the outer periphery of the ion detection apparatus, favorably maintain airtightness of the ion detection apparatus 100, and reduce the leakage of the taken gas.

Although some embodiments of the present disclosure have been described above, the present disclosure is not limited to the specific embodiments, and various modifications and changes can be made within the scope of the gist of the present disclosure described in the claims unless otherwise limited in particular in the above description.

The embodiment described above is one example and attains advantages below in the following aspects.

### First Aspect

According to a first aspect, an ionization device (e.g., the ionization device 1) includes a pair of electrodes that generate a discharge region and a channel tube (e.g., the outflow tube 51b) through which a gas flows to the discharge region. The pair of electrodes includes a first electrode (e.g., the discharge needle 2) and a second electrode (e.g., the electrode portion 4a) annularly disposed around a tip (e.g., the tip 2a) of the first electrode. A diameter (e.g., the diameter d) of a gas outflow port (e.g., the outflow port 54) of the channel tube through which the gas flows to the discharge region is smaller than a diameter (e.g., the diameter D) of the second electrode.

According to this, as described in relation to the above-described embodiment, since the diameter (inner diameter) of the gas outflow port of the channel tube is smaller than the diameter of the second electrode, the amount of gas flowing around the first electrode can be increased as compared with the case where the diameter of the gas outflow port of the channel tube is equal to or larger than the diameter of the second electrode. Accordingly, the taken gas can be efficiently ionized by the discharge from the first electrode, and the ionization rate of the gas can be increased.

### Second Aspect

According to a second aspect, in the ionization device (e.g., the ionization device 1) of the first aspect, the channel tube (e.g., the outflow tube 51b) is electrically conductive, and the channel tube and the first electrode (e.g., the discharge needle 2) have the same potential. According to this, as described in relation to the above-described embodiment, it is possible to reduce the occurrence of abnormal discharge between the channel tube and the first electrode (e.g., the discharge needle 2).

### Third Aspect

According to a third aspect, the ionization device (e.g., the ionization device 1) of the second aspect includes an electrode tube (e.g., the electrode tube 4) having the second electrode (e.g., the electrode portion 4a). The electrode tube (e.g., the electrode tube 4) covers a part of the channel tube (e.g., the outflow tube 51b). A distance (e.g., the distance L1) between the second electrode and the first electrode (e.g., the discharge needle 2) in a direction orthogonal to a flow direction of the gas is shorter than a distance (e.g., the distance L2) between the channel tube and the electrode tube (e.g., the electrode tube 4) in the direction orthogonal to the gas flow direction.

According to this, as described in relation to the above-described embodiment, it is possible to reduce the occurrence of an abnormal discharge between the electrode tube (e.g., the electrode tube 4) and the channel tube (e.g., the outflow tube 51b), and generate a discharge dominantly and stably between the first electrode (e.g., the discharge needle 2) and the second electrode (e.g., the electrode portion 4a), so that the gas can be ionized efficiently.

### Fourth Aspect

According to a fourth aspect, the ionization device (e.g., the ionization device 1) of the third aspect includes the electrode tube (e.g., the electrode tube 4) having the second electrode (e.g., the electrode portion 4a). The second electrode is a portion that protrudes inward from a downstream end of the electrode tube (e.g., the electrode tube 4) in the flow direction of the gas.

According to this, as described in relation to the above-described embodiment, the distance (e.g., the distance L1) between the second electrode and the first electrode (e.g., the discharge needle 2) in the direction orthogonal to the gas flow direction can be made shorter than the distance (e.g., the distance L2) between the channel tube and the electrode tube (e.g., the electrode tube 4) in the direction orthogonal to the gas flow direction.

### Fifth Aspect

According to a fifth aspect, in the ionization device (e.g., the ionization device 1) of the fourth aspect, the tip of the first electrode (e.g., the discharge needle 2) is disposed at the same position as the second electrode (e.g., the electrode portion 4a) in the flow direction of the gas.

According to this, the discharge can be concentrated on the second electrode (e.g., the electrode portion 4a), and the electrode discharge can be reduced from spreading to the downstream side in the gas flow direction. Accordingly, the discharge can be favorably performed in the direction orthogonal to the gas flow direction, the probability of contact with the gas can be improved, the amount of gas molecules to be ionized is increased, and the efficiency of ionization is improved.

### Sixth Aspect

According to a sixth aspect, the ionization device (e.g., the ionization device 1) of any one of the second to fifth aspects includes a conductive electrode holder (e.g., the conductive electrode holder 6), an electrode adapter (e.g., the electrode adapter 33), and an insulating holder (e.g., the insulating holder 7). The conductive electrode holder (e.g., the conductive electrode holder 6) is attached to a conductive channel member (e.g., the conductive channel member 5) having the channel tube (e.g., the outflow tube 51b) and holds the first electrode (e.g., the discharge needle 2). The electrode adapter (e.g., the electrode adapter 33) is electrically connected to the channel member (e.g., the channel member 5), has a channel through which the gas flows, and has an outer peripheral portion to which a voltage is applied. The electrode tube (e.g., the electrode tube 4) and the electrode adapter (e.g., the electrode adapter 33) are attached to the insulating holder (e.g., the insulating holder 7). According to this, as described in relation to the above-described embodiment, a voltage can be input to the first electrode (e.g., the discharge needle 2) via the electrode adapter (e.g., the electrode adapter 33), the channel member (e.g., the channel member 5), and the electrode holder (e.g., the electrode holder 6). The channel member and the first electrode can be set to the same potential, so that it is possible to prevent an abnormal discharge between the channel tube and the first electrode.

The electrode adapter (e.g., the electrode adapter 33) and the electrode tube (e.g., the electrode tube 4) can be insulated from each other by an insulating holder (e.g., the insulating holder 7), so that it is possible to prevent the occurrence of a short circuit or an abnormal discharge between the electrode adapter (e.g., the electrode adapter 33) and the electrode tube (e.g., the electrode tube 4). Since a voltage is applied to the outer peripheral portion of the electrode adapter, airtightness of the inside can be secured.

### Seventh Aspect

According to a seventh aspect, in the ionization device (e.g., the ionization device 1) of the sixth aspect, the electrode holder (e.g., the electrode holder 6) is detachably attached to the channel member (e.g., the channel member 5), and the electrode tube (e.g., the electrode tube 4) and the electrode adapter (e.g., the electrode adapter 33) are separably joined to an insulating holder (e.g., the insulating holder 7).

According to this, as described in relation to the above-described embodiment, separating the electrode adapter (e.g., the electrode adapter 33) from the insulating holder (e.g., the insulating holder 7) and removing the electrode holder (e.g., the electrode holder 6) from the channel member (e.g., the channel member 5) makes it possible to replace the deteriorated discharge electrode (e.g., the discharge needle 2). Accordingly, a fresh discharge electrode can be easily used at all times, and the gas can be ionized efficiently by stable discharge.

### Eighth Aspect

According to an eighth aspect, in the ionization device (e.g., the ionization device 1) of any one of the first to seventh aspects, the electrode tube (e.g., the electrode tube 4) and the channel tube (e.g., the outflow tube 51b) are formed of different members.

According to this, as described in relation to the above-described embodiment, the shapes of the electrode tube (e.g., the electrode tube 4) and the channel tube (e.g., the outflow tube 51b) can be designed without constraints. Accordingly, it is possible to generate a favorable discharge between the discharge electrode (e.g., the discharge needle 2) and the electrode tube (e.g., the electrode tube 4), and to flow the gas to the discharge region so that the taken gas can be ionized most efficiently. Accordingly, the efficiency of ionization can be enhanced.

### Ninth Aspect

According to a ninth aspect, in the ionization device (e.g., the ionization device 1) of any one of the first to eighth aspects, an air pressure at the gas outflow port (e.g., the outflow port 54) of the channel tube (e.g., the outflow tube 51b) is less than an atmospheric pressure.

According to this, as described in relation to the above-described embodiment, it is possible to flow the gas along the direction in which the gas flows from the gas outflow port (e.g., the outflow port 54) as compared with the case where the air pressure in the channel tube is made higher than the atmospheric pressure and the gas flows from the gas outflow port by pressurization. Accordingly, the gas flowing out from the gas outflow port can favorably flow to the tip (e.g., the tip 2a) of the discharge electrode (e.g., the discharge needle 2), and the efficiency of ionization of the gas can be enhanced.

### Tenth Aspect

According to a tenth aspect, an ion detection apparatus (e.g., the ion detection apparatus 100) includes the ionization device (e.g., the ionization device 1) and an ion detection unit (e.g., the ion detection unit 101). The ion detection unit includes an ion filter (e.g., the ion filter 110) that sorts a gas ionized by the ionization device (e.g., the ionization device 1), and an ion detection electrode (e.g., the ion detection electrode 120) that detects the ionized gas. The ionization device (e.g., the ionization device 1) is the ionization device according to any one of the first to ninth aspects.

According to this, since the gas can be efficiently ionized by the ionization device (e.g., the ionization device 1), the ion concentration of the gas flowing into the ion detection unit (e.g., the ion detection unit 101) can be increased. Accordingly, neutral molecules that are noise components are reduced, and the detection sensitivity can be improved.

### Eleventh Aspect

According to an eleventh aspect, in the ion detection apparatus (e.g., the ion detection apparatus 100) of the tenth aspect, an electrode tube (e.g., the electrode tube 4) is connected to the ion detection unit (e.g., the ion detection unit 101) via an insulator.

According to this, as described in relation to the above-described embodiment, it is possible to form a potential difference between the electrode tube and the chip holder of the ion detection unit for flowing the ionized gas having charges to the ion filter (e.g., the ion filter 110).

### Twelfth Aspect

According to a twelfth aspect, a gas analysis apparatus (e.g., the gas analysis apparatus 200) includes the ion detection apparatus (e.g., the ion detection apparatus 100) and analyzes a gas based on a result of detection by the ion detection apparatus (e.g., the ion detection apparatus 100). The ion detection apparatus is the ion detection apparatus according to the tenth or eleventh aspect.

According to this, the gas can be analyzed with high accuracy.

This patent application is based on and claims priority to Japanese Patent Application Nos. 2022-206620, filed on Dec. 23, 2022, and 2023-196664, filed on Nov. 20, 2023, in the Japan Patent Office, the entire disclosure of each of which is hereby incorporated by reference herein.

### REFERENCE SIGNS LIST

1: Ionization device
2: Discharge needle
2a: Tip of discharge needle
4: Electrode tube
4a: Electrode portion
4b: Female screw portion
4c: Male screw portion
5: Channel member
6: Electrode holder
7: Insulating holder
7a: Female screw portion
7b: Male screw portion
9: Channel tube
10: Circuit board
14: Vacuum pump
15: Coupling holder
15a: Female screw portion
15b: Female screw portion
16: First flange
16a: Male screw portion
16b: Channel portion
17: First insulating holder
17a: Male screw portion
19: Chip holder
20: Second flange
20a: Channel
24: Groove portion
26: Groove portion
28: Insulating convex portion
33: Electrode adapter
33a: Female screw portion
33b: Male screw portion
51a: Inflow tube
51b: Outflow tube
52: Connection convex portion
53: Holder fitting portion
54: Outflow port
100: Ion Detection Apparatus
101: Ion detection unit
110: Ion filter
120: Ion detection electrode
136: Boundary layer
137: Laminar flow
200: Gas analysis apparatus
200a: Case
300: Gas conveyance apparatus
301: Flow rate sensor
304: Intake portion
304a: Intake port
305: Exhaust portion
D: Inner diameter of electrode tube
d: Diameter of outflow port
L1: Distance between electrode tube and discharge needle
L2: Distance between electrode tube and outflow tube
L4: Channel length of outflow tube

1. An ionization device, comprising:
a pair of electrodes to generate a discharge region; and
a channel tube through which a gas flows, the channel tube include a gas outflow port,
the pair of electrodes including:
a first electrode; and
a second electrode annularly disposed around a tip of the first electrode,
wherein a diameter of the gas outflow port through which the gas flows to the discharge region is smaller than a diameter of the second electrode.

2. The ionization device according to claim 1, wherein:
the channel tube is electrically conductive, and
the channel tube and the first electrode have a same potential.

3. The ionization device according to claim 2, further comprising:
an electrode tube having the second electrode,
wherein:
the electrode tube covers at least a part of the channel tube, and
a distance between the second electrode and the first electrode in a direction orthogonal to a flow direction of the gas is shorter than a distance between the channel tube and the electrode tube in the direction orthogonal to the flow direction of the gas.

4. The ionization device according to claim 3, wherein:
the second electrode is a portion protruding inward from a downstream end of the electrode tube in the flow direction of the gas.

5. The ionization device according to claim 4, wherein:
the tip of the first electrode is disposed at the same position as the second electrode in the flow direction of the gas.

6. The ionization device according to claim 2, further comprising:
a conductive electrode holder that is attached to a conductive channel member having the channel tube and holds the first electrode;
an electrode adapter that is electrically connected to the conductive channel, has a channel through which the gas flows, and has an outer peripheral portion to which a voltage is applied; and
an insulating holder to which an electrode tube having the second electrode and the electrode adapter are attached.

7. The ionization device according to claim 6, wherein;
the conductive electrode holder is detachably attached to the conductive channel, and
the electrode adapter is separably joined to the insulating holder.

8. The ionization device according to claim 1,
wherein the second electrode and the channel tube are different element.

9. The ionization device according to claim 1, wherein;
an air pressure at the gas outflow port of the channel tube is less than an atmospheric pressure.

10. An ion detection apparatus, comprising:
the ionization device according to claim 1; and
an ion detector including:
an ion filter to sort a gas ionized by the ionization device; and
an ion detection electrode to detect the ionized gas.

11. The ion detection apparatus according to claim 10, wherein:
an electrode tube having the second electrode is connected to the ion detector via an insulator.

12. A gas analysis apparatus, comprising:
the ion detection apparatus according to claim 10,
wherein the gas analysis apparatus analyzes a gas based on a result of detection by the ion detection apparatus.
